(19) United States
(12) Patent Application Publication
(10) Pub. No.: US 2003/0155377 A1
(43) Pub. Date: Aug. 21, 2003

(54) Finger-operated spray pump ejaculating fluid in fixed quantity

(76) Inventor: Chung Kee Lee, Seoul (KR)

Correspondence Address: Mavis S Gallenson, Lada & Parry, Suite 2100, 5670 Wilshire Boulevard, Los Angeles, CA, 90036-5679, US

(21) Appl. No.: 10/275,152

(22) PCT Filed: May 30, 2001
(86) PCT No.: PCT/KR01/00910

(30) Foreign Application Priority Data
Mar. 23, 2001 (KR) 2001/0015217

(51) Int. Cl. G01F 11/06

(52) U.S. Cl. 222/321.7

(57) ABSTRACT

The present invention relates to a finger-operated spray pump ejaculating fluid in fixed quantity at one time pumping, and more particularly a spray pump in which a poppet valve and a sliding seal are made as one unit and the structure of housing is modified for lower defect rate and improved convenience.

### TECHNICAL FIELD

The present invention is directed to a finger-operated spray pump ejaculating liquid contents in a fixed quantity at one-time pumping, and more particularly a spray pump in which a poppet valve and a sliding seal are made as one unit and the structure of housing is modified for lower defect rate and improved convenience.

### BACKGROUND ART

Finger-operated spray pumps have been used to the upper caps of liquid-containing vessels such as metal cans, glass bottles and plastic bottles, i.e., vessels containing liquids like perfumes, hair-spraying agent, deodorizing agents, neck-spraying agent and the like. Using of the spray pumps relieves the troublesome operation of opening and closing the cap of vessels and difficulty of spraying in a fixed quantity. Moreover, liquid contents contained in the vessels are not almost dried and deteriorated by external materials because the contents are continuously kept under the closed state.

The representative example of these finger-operated fixed-quantity spray pump is shown in U.S. Pat. No. 5,277,559. The structure and operation of the spray pump in the above patent will be described with reference to FIGS. 1 and 2.

Referring to FIG. 1, the conventional finger-operated fixed-quantity spray pump comprises an actuator (100), a pump member (200) and a sealing cap (300) in a whole view.

A piston (220) with an influx passage therein is engaged to the lower portion of actuator (100). The actuator (100) has an ejecting nozzle (not shown) led to the influx passage of piston (220).

The pump member (200) includes a housing (210) forming the external appearance, a piston (220) being engaged to the actuator (100) and moving upward/downward in the housing (210), a poppet valve (230) being installed in the piston (220), a sliding seal (240) being close-contacted to the inner surface of housing (210) and being installed in the lower portion of poppet valve (230), a spring (250) being installed between sliding seal (240) and the lower portion of housing (210).

The sliding seal (240) is disposed on the lower portion of housing (210) and poppet valve (230) at their axis direction, and assembled to move together with poppet valve (230).

A tube (not shown) is extended to the inner bottom of a vessel containing liquid contents and engaged to the lower end of pump (200).

The spring (250) is disposed in the pump member (200), and its lower end is mounted in the lower space of housing (210) and its upper end is engaged to a downward extension pin of poppet valve (230).

The sealing cap (300) is combined to the corresponding portions of housing (210) and piston (220), with a liner (310) being installed to prevent the leakage of liquid contents.

The operation way of the finger-operated fixed-quantity spray pump having such structure will be described with reference to FIGS. 1 and 2.

When the actuator (100) is pressurized, the pressure is transferred to the poppet valve (230) and sliding seal (240) via the piston (220). At this time, a downward slope (231) at the lower portion of poppet valve (230) becomes contacted to an inner lip (241) of sliding seal (240), and an outer downward slope (242) of sliding seal (240) becomes contacted to an upward slope (213) of a housing bead (212). As the poppet valve (230) goes down continuously, the inner lip (241) of sliding seal (240) slides on an outer surface (2310) beyond the downward slope (230) of poppet valve (230). Since the outer surface (2310) of poppet valve (230) and the inner lip (241) of sliding seal (240) are s kept at the closed-contact state, an upper space (A) of housing (210) is closed against a lower space (B). Therefore, the continuous going-down pressurizes the liquid contents being in upper space (A). When the pressure of liquid contents is sufficient to overcome the spring (250) force, the closed-contact portion of piston (220) and poppet valve (230) becomes opened, and the liquid contents goes up through the opened portion.

Upon release of any actuating force on the actuator (100), the piston (220) and poppet valve (230) go up together with the sliding seal (240). At this time, the opened space between the piston (220) and poppet valve (230) becomes closed again by the spring (250) force, the closed-contact between the outer downward slope (242) of sliding seal (240) and the upward slope (213) of housing bead (212) is disengaged, thereby allowing the upper space (A) and lower space (B) of the housing (210) to be connected through an influx passage (243) to make the flow of liquid contents possible. The sliding seal (240) goes up only until the outer upper slop (244) of sliding seal (240) becomes contacted to the downward slope (214) of housing bead (212). The outer surface (2310) of poppet valve (230) goes up continuously, with keeping the closed-contact state to the inner bead (214) of sliding seal (240), even after the contact of the above two units (244, 214), and finally the closed-contact is disengaged upon arrival at the downward slope (2310). Accordingly, the liquid contents in the housing lower space (B) flow into the housing upper space (A) so as to recover the pressure.

As described above, in the figure-operated fixed-quantity spray pump of such structure and operation, the poppet valve (230) and sliding seal (240), and the inner bead (212) conducting the opening/closing procedure by its mutuality with the above two units (230, 240) are very important. However, in an injection molding of plastic, it is difficult to make the inner bead (212) in the identical form as designed because it is deeply located on the inner surface of the housing (210), particularly, in the case of very small size products like the figure-operated fixed-quantity spray pump. In other words, even the small error of molded product may make the operation of spray pump impossible. For example, if the protruding high of the inner bead (212) is a little lower than that in the design, the outer downward slope (241) of sliding seal (240) cannot keep the closed-contact state to the upper slope (213) of inner bead (212) and resultantly goes beyond the inner bead (212), which make the pumping impossible as described above. Furthermore, it is very difficult to check such defect of the inner bead (212).

Meanwhile, the ejection amount of the spray pump at one-time pumping depends upon the volume of a precompression part (corresponding to “A”), and in order to increase the ejection amount of one-time pumping, the volume of A should be increased, which requires extending the length or diameter of housing.

However, the demand on the small-size pump is actually very high for the elegance of appearance. The pump structure of the above U.S. patent has the inevitably small volume of precompression part (A) because many units are necessary for operation.

Moreover, the sliding seal (240) is mainly made of polyethylene resin for the flexibility of unit; however, the polyethylene resin has a low dimensional-stability at the higher temperature of molding procedure due to its low melting point.

Therefore, the structure of spray pump capable of solving said problems is strongly required.

### DISCLOSURE OF INVENTION

The objects of the present invention are to solve the problems described above for once and all.

That is, it is an object of the present invention to provide a finger-operated fixed-quantity spray pump of being easily fabricated and having a remarkably low defect rate by modifying the configuration of a housing and poppet valve.

A further object of the present invention is to simplify the overall structure by not comprising a sliding seal as an independent unit, whereby making the fabrication process easier and diminishing the defect rate and resultantly reducing the number of fabrication steps to lessen the manufacturing cost.

Another object of the present invention is to provide the pump structure having the large volume of precompression part capable of increasing the ejection amount of one-time pumping by reducing the number of units.

Another object of the present invention is to provide the pump structure capable of controlling the ejection amount of one-time pumping.

In order to accomplish these objects, the present invention provides a finger-operated fixed-quantity spray pump, comprising an actuator engaged on the upper portion of a pump for ejecting liquid contents, a pump member of sucking the liquid contents from a vessel and then providing them with the actuator, and a sealing cap of engaging the pump member to the vessel and sealing the interior of the pump member from the exterior, wherein,

the pump member comprises a housing of forming the external appearance of pump member, a piston of being engaged to the lower portion of actuator and moving upward/downward along the inner surface of housing and having an influx passage axis-directionally, a poppet valve of having a rod for opening/closing of the influx passage of piston at its upper portion and being connected to a spring at its lower portion, and a spring of being mounted in the lower inner portion of the housing,

the poppet valve has a lateral extension part of being extended laterally, a lower extension part of being inserted in a inner tube of housing lower portion upon the going-down of the poppet valve and being engaged with the part of spring at its upper portion, and grooves of being formed on the lower extension part, and

the housing has an inner tube of being located inside the spring and extended upward from an inlet.

The finger-operated fixed-quantity spray pump of the present invention sucks the liquid contents into the pump member and then sends them to the actuator by the closed-contact/separation of the lower extension part of poppet valve and the inner tube of housing at pumping; therefore, an independent sliding seal is not necessary. More specifically, upon pressurization of the actuator, the lower extension part of poppet valve is inserted in the inner tube of housing at the closed-contact state, thereby allowing the internal space of housing to be closed. To the contrary, upon release of the pressure, the liquid contents in the vessel enter the housing through the gap formed between the grooves of lower extension part and the inner tube of housing.

Accordingly, the outer diameter of the lower extension part of poppet valve should be almost identical to the inner diameter of the inner tube of housing for securing the closed-contact state, and the grooves of lower extension part should be carved to the extent capable of being separated from the inner diameter of the inner tube.

The length of the grooves may depend upon the ejection amount of pumping and is generally in the range of approximately 0.5 to 1.0 mm. If the length of the grooves is relatively small, the ejection amount becomes large. To the contrary, if the length of the grooves is relatively large, the ejection amount becomes small. That is because, in the case of the large-length grooves, the amount of liquid contents to be leaked toward the inner tube upon the pressing is diminished, thereby allowing the ejection amount to be diminished. Therefore, since the ejection amount can be controlled by adjusting the length of the grooves, it is possible to control the ejection amount without transforming other units or changing the overall size of pump. Furthermore, since the spray pump can be operated without the sliding seal used in the prior arts, the volume of the compression part becomes large for storing and pressurizing the contents.

The shape of the housing inner tube may be a simple cylindrical structure or in any case a complex cylindrical structure wherein protrusions corresponding to the grooves of poppet valve are formed at the upper inner portion of inner tube. At the latter, for securing the smooth operation, there should also be an influx gab separated between the grooves of lower extension part and the protrusions of inner tube, as described above. More preferably, the grooves are formed along the outer surface of the lower extension part and the corresponding protrusions are formed along the inner surface of the inner tube at the same manner.

These configurations may be diversely transformed under the above basic structure. In an exemplary configuration, a plurality of grooves are formed along the inner surface of the lower extension of poppet valve, and an aperture communicating with the internal space of housing is perforated at the upper portion of the popper valve, and a plurality of protrusions corresponding to the grooves are formed on the upper outer surface of the housing inner tube. The contrary configurations are also available in which the grooves are formed the upper outer or inner surface of the housing inner tube, and the corresponding protrusions are formed the inner or outer surface of the lower extension part of poppet valve.

As described above, the lateral extension part is downward extended as a certain length. Accordingly, the overall cross-sectional shape shows that a “ [symbol] ” shape (for the right lateral part) resulted from the combination of a horizontal part and a vertical part faces the corresponding opposite shape. The whole surface of the horizontal part does not contact to an inner surface of housing not to obstruct the flow of liquid contents. Preferably, one or more inducing protrusions are attached to the part or whole of an outer surface of lateral part. That is, the space between the inducing protrusions enables the passage of the contents and makes the poppet valve move stably under the closed-contact state to the inner surface of housing. In particular, the existence of the inducing protrusions helps the lower extension part of poppet valve to move upward/downward along the inner tube of housing without shaking. When the poppet valve goes down entirely, a lower end of vertical part arrives at a horizontal surface of housing.

Meanwhile, the distance of pumping depends upon the overall length of the housing and the length of the vertical part of poppet valve. As described above, since the pump structure of the present invention has a larger space of precompression part, in which the pressurization of the contents occurs, than that of the conventional pump, the large change of volume is possible despite of its small diameter. In other words, since the change of diameter causes the change of volume at a subduplicate ratio in the case of the same length, it is possible to change the ejection amount only by the small change of dimension without the essential change of structure. Accordingly, the figure-operated fixed-quantity spray pump of the present invention can be used for a variety of spray pumps having the ejection amount in the range of 50 mcl (1 mcl=1/1000 cc) to 200 mcl.

Furthermore, the units except a ball and spring can be made of polypropylene resin having a high melting point, whereby accomplishing the dimensional-stability under the high temperature and humidity condition.

As shown below, the description refers to the drawing in order to describe the present invention more in detail, thereby, the scope of the invention is however not to be interpreted as a limitation of the invention.

### DETAILED DESCRIPTION OF PREFERRED EMBODIMENTS

FIGS. 3 and 4 show the finger-operated fixed-quantity spray pump according to an embodiment of the present invention at the state of going-up piston and going-down piston each other. Referring to these figures, the spray pump of the present invention comprises an actuator (not shown), a pump member (200), a sealing cap (300), etc., and an upper inserting part (260) of pump member (200) is engaged to the lower portion of the actuator, and a tube (400) is engaged into the lower end of a housing (210).

The pump member (200) includes the housing (210), a piston (220), a poppet valve (230) and a spring (250) as main constitutional elements. Liquid contents contained in a vessel (not shown) flow into the pump member (200) and then go up to the actuator via an influx passage (261) of the piston (220).

FIG. 5 shows the region (“X”) between a lower end of a lower extension part (232) of poppet valve (230) and an inner tube (215) of housing (210) at the spray pump state in FIG. 3. Grooves (2320) are formed on the outer surface of the lower extension (232), and protrusions (2150) corresponding to the grooves (2320) are formed the upper outer surface of the inner tube (215). The grooves (2320) and protrusions (2150) are somewhat separated from each other and the liquid contents flow into the pump member (200) through the separated gap.

FIG. 6 shows the region (“Y”) in which the influx passage (261) of an upper inserting part (260) of piston (220) is closed by a rod (236) of poppet valve (230) at the spray pump state in FIG. 3. The region (Y) is opened only when the internal pressure is pressurized by the going-down of the piston (220) and poppet valve (230) and it comes to the pretty extent. As the pressurized contents leak out to the influx passage (261) by opening of the region (Y) and thus the internal pressure of housing (210) decreases, the region (Y) becomes closed again by the spring (250) force even before the piston (220) and poppet valve (230) arrive at the lowest point.

FIG. 7 shows the region (“Z”) between a lower extension part (232) and a lateral extension part (234) of poppet valve (230) and an inner tube (215) of housing (210). The lateral extension part (234) consists of a horizontal part (2341) extended horizontally from the lower extension part (232) and a vertical part (2342) extended downward from the horizontal part (2341). On the vertical part (2342), a plurality of inducing protrusions (2343) are formed which are protruded toward the housing (210). Referring to FIG. 7, the inducing protrusions (2343) are a little separated from the inner surface of housing (210) but, in any case, the inducing protrusions (2343) are almost closed-contacted to the inner surface of housing (210).

The going-down of poppet valve (230) stops when the vertical part (2342) of lateral extension part (234) arrives at a lower surface (214) of housing (210). In any case, the vertical part (2342) may be omitted, and in this case, the going-down of poppet valve (230) stops when the upper end of the inner tube (215) of housing (210) arrives at the lower end of the horizontal part (2341) of lateral extension part (234). However, it is not desirable because the inner tube (215) may be easily damaged at the time of frequent pumping or applying excess force due to its thinner thickness than that of the vertical part (2342).

Upon going-down of poppet valve (230), the inner tube (215) of housing (210) goes beyond the grooves (2320) of lower extension part (232) and then slides on an outer surface (2322) of lower extension part (232) at the closed-contact state. In case that protrusions (2150) are formed the upper portion of the inner tube (215), as described above, the protrusions (2150) go beyond the grooves (2320) of lower extension part (232) and then slide on its outer surface (2322). The sliding movement can be carried out at the closed-contact state by the elasticity of plastic being materials for the poppet valve (230) and/or housing (210).

FIG. 8 shows the vertical cross-sectional view and bottom view of an exemplary poppet valve useful for the present invention. A poppet valve (230) includes a rod (236) inserted into the piston (220) at its upper portion and a space (238) for inserting the part of spring (250) therein at its lower portion. The space (238) includes a lower extension part (232) and a lateral extension part (234), and the extension part (234) consists of a horizontal part (2341), a vertical part (2342) and inducing protrusions (2343). At the lower extension part (232), a plurality of grooves (2320) are regularly formed along its circumference. Also at the lateral extension part (234), a plurality of inducing protrusions (2343) are radially formed along its circumference. The lengths of grooves (2320) and vertical part (2343) can be changed depending upon the ejection amount of one-time pumping, as described early.

FIG. 9 shows the flow of liquid contents in the process that the liquid contents from the tube flow into the internal space of pump member (200) as going-up of the piston (220) and poppet valve (230), and FIG. 10 shows the flow of liquid contents in the process that the liquid contents being introduced in the pump member (200) go up to the actuator through the influx passage (261) upon going-down of the piston (220) and poppet valve (230).

The present invention being thus described, it will be obvious that the same may be varied in many ways. Such variations are not to be regarded as a departure from the spirit and scope of the invention and all such modifications would be obvious to one skilled in the art.

### BRIEF DESCRIPTION OF DRAWINGS

FIG. 1 is a vertical cross-sectional view of the conventional finger-operated fixed-quantity spray pump at the pressurized state.

FIG. 2 is a vertical cross-sectional view of the spray pump of FIG. 1 at the pressure-released state.

FIG. 3 is a vertical cross-sectional view of the finger-operated fixed-quantity spray pump according to an embodiment of the present invention at the pressurized state.

FIG. 4 is a vertical cross-sectional view of the spray pump of FIG. 3 at the pressure-released state.

FIG. 5 is a magnified view of “X” region in FIG. 3.

FIG. 6 is a magnified view of “Y” region in FIG. 3.

FIG. 7 is a magnified view of “Z” region in FIG. 4.

FIG. 8 is a vertical cross-sectional and bottom view of the poppet valve according to an embodiment of the present invention.

FIG. 9 is a flow view of liquid contents at the pressure-released state in the finger-operated fixed-quantity spray pump according to an embodiment of the present invention.

FIG. 10 is a flow view of liquid contents at the pressurized state in the spray pump of FIG. 9.

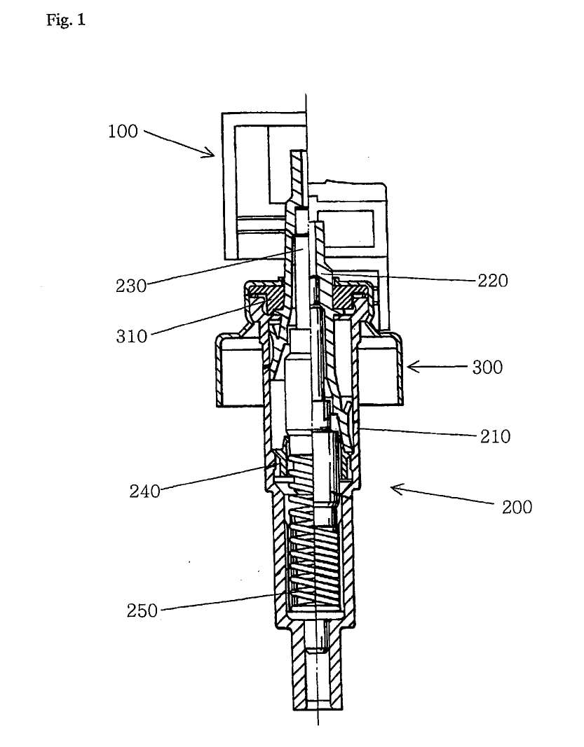

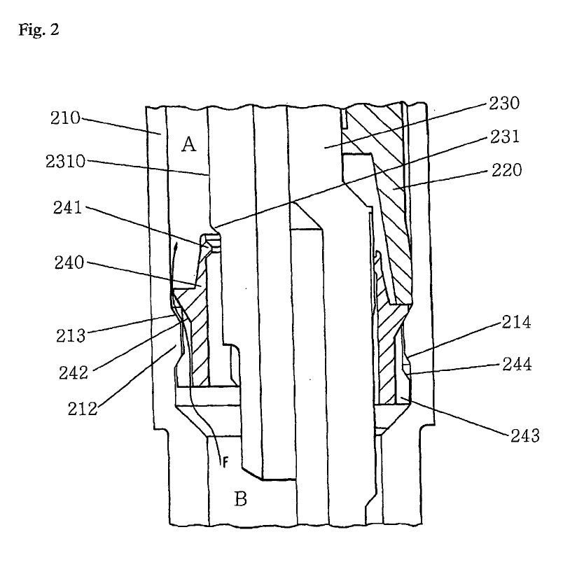

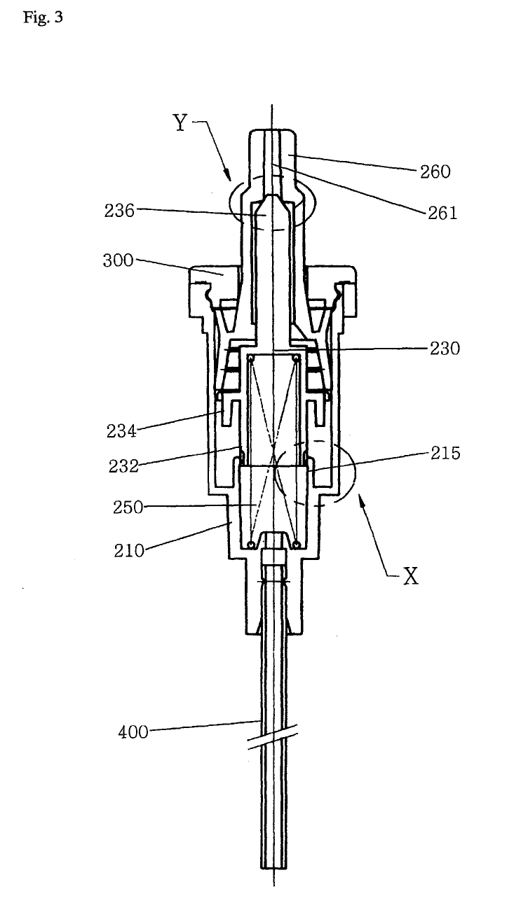

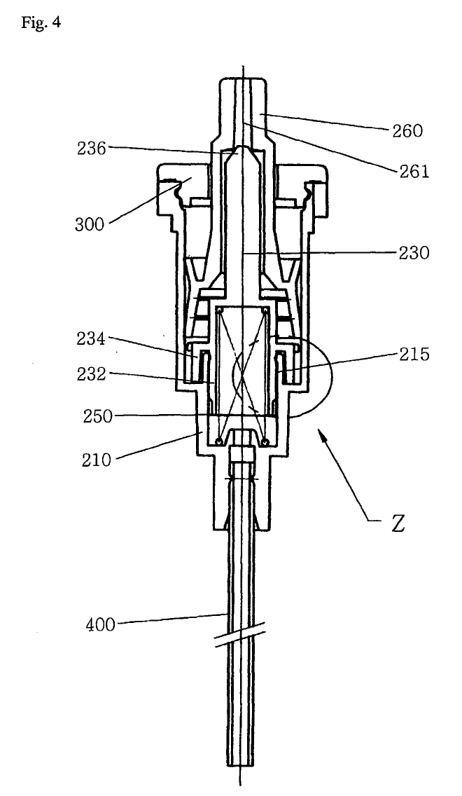

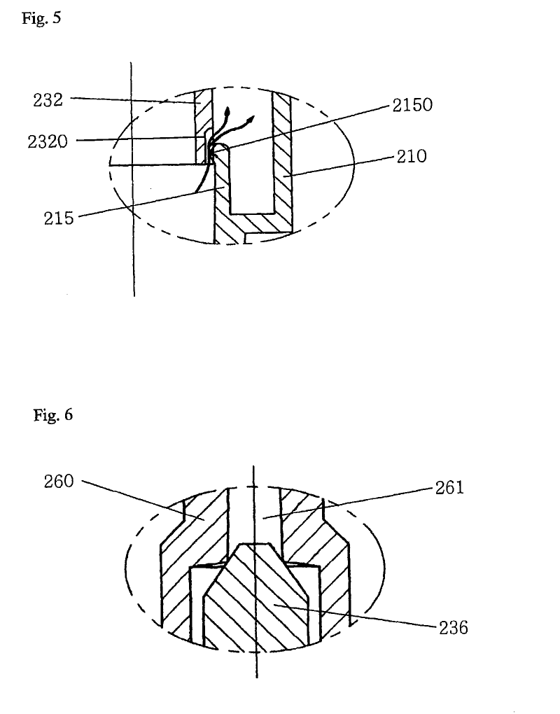

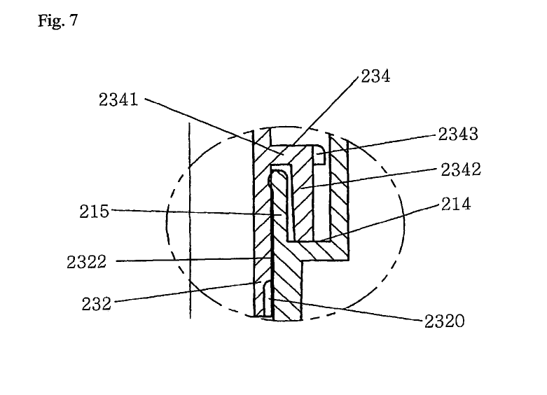

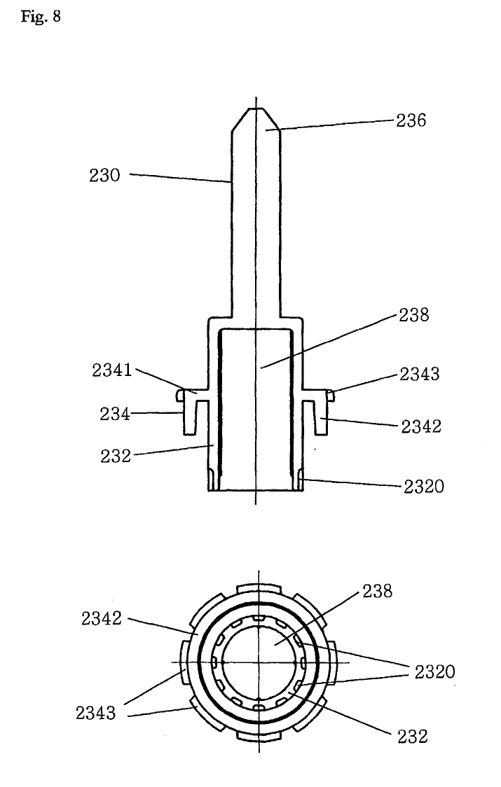

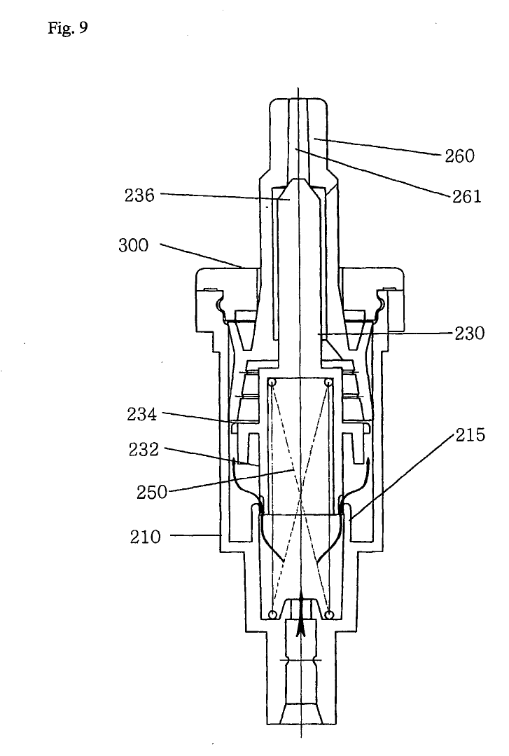

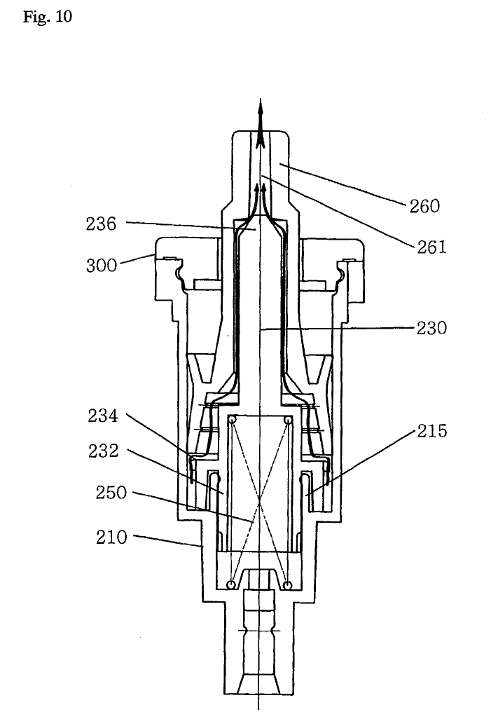

DESIGNATION OF THE REFERENCE NUMBERS

| | |
|---|---|
| 100: actuator | 200: pump member |
| 210: housing | 220: piston |
| 230: poppet valve | 240: sliding seal |
| 250: spring | 300: sealing cap |
| 400: tube | |

### INDUSTRIAL APPLICABILITY

As described above, the finger-operated fixed-quantity spray pump according to the present invention is fabricated with the smaller number of units and the simpler configuration than those of the conventional spray pump. Moreover, the spray pump according to the present invention does not have the problem in view of the molding process, compared to the conventional spray pump in which it is difficult to form the inner bead, whereby its defect rate is considerably low. Additionally, since it is possible in the present invention to easily control the ejection amount of one time pump just by adjusting the dimension of the part of units without the overall change of structure.

What is claimed is:

1. A finger-operated fixed-quantity spray pump, comprising an actuator fixed on the upper portion of pump for ejecting liquid contents, a pump member of sucking the liquid contents from a vessel and providing them with the actuator, and a sealing cap of fixing the pump member to the vessel and sealing the interior of the pump member from the external, wherein,
the pump member comprises a housing of forming the external appearance of pump member, a piston of being engaged to the lower portion of actuator and moving upward/downward along the inner surface of housing and having an influx passage axis-directionally, a poppet valve of having a rod for opening/closing of the influx passage of piston at its upper portion and being connected to a spring at its lower portion, and a spring of being mounted in the lower inner portion of the housing,
the poppet valve has a lateral extension part of being extended laterally, a lower extension part of being inserted in a inner tube of housing lower portion upon the going-down of the poppet valve and being engaged with the part of spring at its upper portion, and grooves of being formed on the lower extension part, and
the housing has an inner tube of being located inside the spring and extended upward from an inlet.

2. The finger-operated fixed-quantity spray pump according to claim 1 wherein the shape of said housing inner tube is a simple cylindrical structure or a complex cylindrical structure with protrusions corresponding to the grooves of poppet valve formed at the upper inner portion of inner tube.

3. The finger-operated fixed-quantity spray pump according to claim 1 wherein the ejection amount of one-time pumping can be controlled by adjusting the length of said housing and the length of said lateral extension part without changing the structures of other constitutional units.

4. The finger-operated fixed-quantity spray pump according to claim 1 wherein said lateral extension part comprises a horizontal part extended horizontally from the lower extension part and a vertical part extended downward from the horizontal part, and on the vertical part, inducing protrusions are formed toward said housing.
